(19) United States
(12) Patent Application Publication
(10) Pub. No.: US 2003/0200841 A1
(43) Pub. Date: Oct. 30, 2003

(54) Articulation lock and pivotable tool using same

(75) Inventor: Scott Novotny, Winthrop Harbor, IL (US)

Correspondence Address: GREER, BURNS & CRAIN, LTD., Suite 2500, 300 South Wacker Drive, Chicago, IL, 60606, US

(73) Assignee: S-B Power Tool Corporation

(21) Appl. No.: 10/131,763

(22) Filed: Apr. 24, 2002

(51) Int. Cl. B25B 23/16

(52) U.S. Cl. 81/177.8

(57) ABSTRACT

An articulation lock that includes a first housing, a second housing, and a lockable connection assembly for pivotably connecting the first housing and the second housing together. The lockable connection assembly includes a plurality of apertures arranged upon a portion of the second housing and at least two lock pins, where each of the lock pins is seated within a cavity located within the first housing. The assembly further includes at least one biasing element for creating a biasing force upon each of the lock pins such that each of the lock pins is biased toward the second housing to prevent relative rotation of the first housing with respect to said second housing and also with respect to an engaging member attached to the second housing. The engaging member includes a plurality of protrusions, with one of the protrusions corresponding to each of the apertures in the second housing. Upon pressing the engaging member towards the lock pins, at least two of the plurality of protrusions push the lock pins against the biasing forces of the biasing elements, allowing relative rotation of the first housing with respect to the second housing.

### BACKGROUND OF THE INVENTION

The present invention relates generally to an articulation lock, as well as to a pivotable tool using the articulation lock, whereby the tool is able to pivot between a plurality of positions, and to be locked in any one of those positions.

One of the objects of the invention is to provide a simple mechanical means for articulating pivotable tools or other devices.

Another object is to provide an improved articulation lock that is capable of being locked into any one of at least four different positions.

An additional object is to provide such an improved articulation lock, and/or a device incorporating such a lock, which is relatively simple to assemble, uses a minimum number of parts, uses standard materials, and is capable of being manufactured at a reasonable cost.

A further object of the present invention is to provide an improved tool incorporating an articulation lock, where that tool may be easily serviced and that lacks large holes or slots that may allow debris or other foreign matter within the housing.

These and other objects of the present invention are described below or will be apparent from the following description.

### BRIEF SUMMARY OF THE INVENTION

The above-listed objects are met or exceeded by the present, articulation lock, which features an articulation lock for allowing a pivotable connection between a first housing portion (such as a handle of a tool) and a second housing portion (such as a motor housing of a tool). The articulation lock preferably includes an engaging member, such as a large button, that may be depressed to disengage locking pins that prevent relative rotation between the first housing portion and the second housing portion. Preferably, the engaging includes a plurality of protrusions that push the locking pins against a spring biasing force. Upon setting the lock at the desired position, the force on the engaging member is withdrawn, and the locking pins once again prevent relative rotation.

More specifically, the present invention provides an articulation lock that includes a first housing, a second housing, and a lockable connection assembly for pivotably connecting the first housing and the second housing together. The lockable connection assembly includes a plurality of apertures arranged upon a portion of the second housing and at least two lock pins, where each of the lock pins is seated within a cavity located within the first housing. The assembly further includes at least one biasing element for creating a biasing force upon each of the lock pins such that each of the lock pins is biased toward the second housing to prevent relative rotation of the first housing with respect to said second housing and also with respect to an engaging member attached to the second housing. The engaging member includes a plurality of protrusions, with one of the protrusions corresponding to each of the apertures in the second housing. Upon pressing the engaging member towards the lock pins, at least two of the plurality of protrusions push the lock pins against the biasing forces of the biasing elements, allowing relative rotation of the first housing with respect to the second housing.

The present articulation lock may be includes into a variety of different devices such as a power screwdriver or other power or non-power tools.

### BRIEF DESCRIPTION OF THE SEVERAL VIEWS OF THE DRAWINGS

Preferred embodiments of the present invention are described herein with reference to the drawings wherein:

FIG. 1 is a perspective view of one form of the present invention—a pivotable tool including an articulation lock;

FIG. 2 is an exploded left side view of FIG. 1;

FIG. 3 is an exploded detailed right side view of FIG. 1;

FIG. 4 is a cross-sectional view of a first embodiment of the articulation lock of FIG. 1, taken along line IV, V-IV, V of FIG. 3; and

FIG. 5 is a modification of the cross-sectional view of FIG. 4.

### DETAILED DESCRIPTION OF THE INVENTION

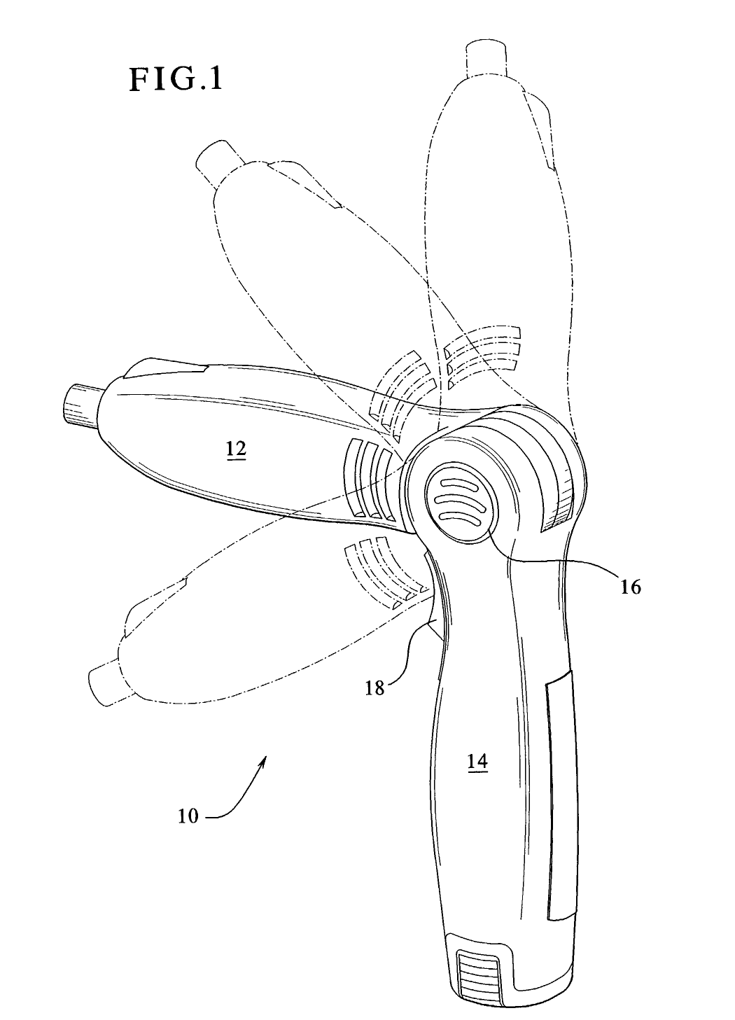

Referring now to the drawings, FIGS. 1-4 show one example of a pivotable tool using the present articulation lock, and FIG. 5 shows a modification of a portion of the lock. It should be noted that although the figures show a cordless screwdriver utilizing the present articulation lock, a screwdriver is just one example of many devices that can utilize the present lock, where such devices include other cordless and corded tools (e.g., drilling tools, finishing tools, cutting tools, etc.), non-powered tools (paint rollers, window cleaning tools, brooms, mops, and other adjustable handled tools), and even frames for carts, baby strollers and other similar devices.

FIG. 1 shows a pivotable screwdriver 10, which includes a motor housing 12 (or first housing 12) and a handle housing 14 (or second housing 14). The motor housing 12 is pivotable with respect to the handle housing 14 about a pivot point that is centered with respect to the engaging member or button 16. As described more fully below, pressing upon the button 16 allows for the motor housing 12 to be pivoted with respect to the handle housing 14, and releasing the button 16 locks the two housing into one of several pre-selected positions. To operate the screwdriver, the trigger 18 is depressed, which activates a motor that rotates the head of the screwdriver, as known to those of ordinary skill in the art.

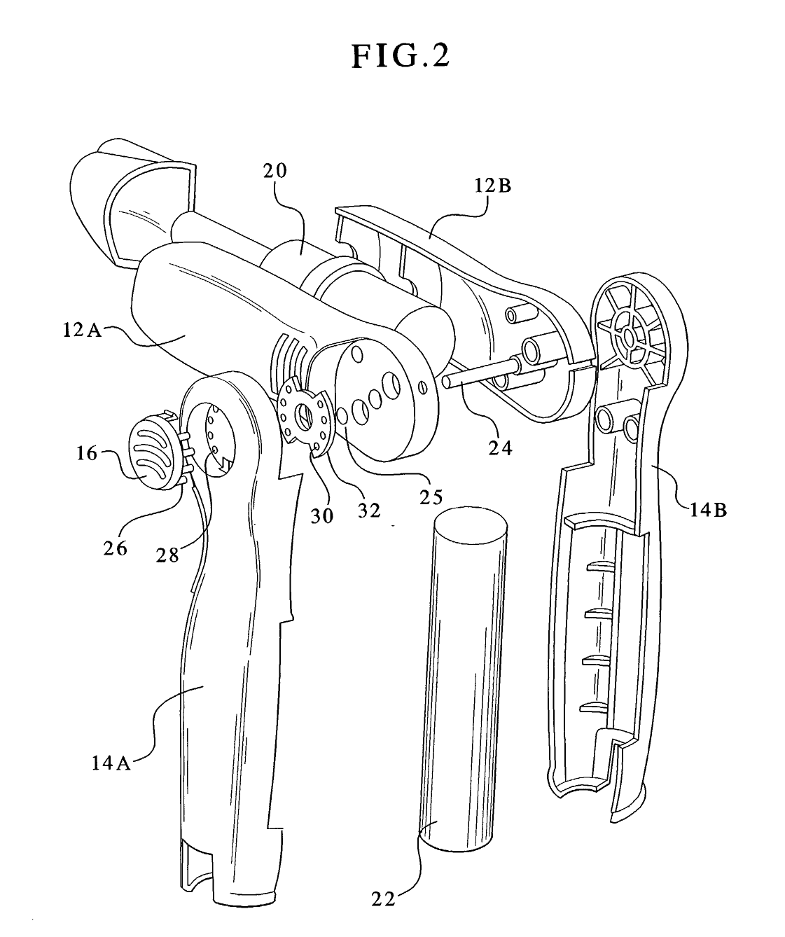

Turning now to FIGS. 2-4, details of the present articulation lock, as incorporated into screwdriver 10, will be described. Preferably, the motor housing 12 is divided into two halves, designated as 12A and 12B, which surround and house a rotary motor 20, which is used for rotating the screwdriver head in a known manner. Seated within the handle housing 14, which is also divided into two halves 14A and 14B, is a battery 22 for powering the motor 20. Battery 22 is preferably rechargeable, although disposable batteries may also be used. Additionally, if the screwdriver 10 is powered by AC current, i.e., is corded, the battery may be omitted.

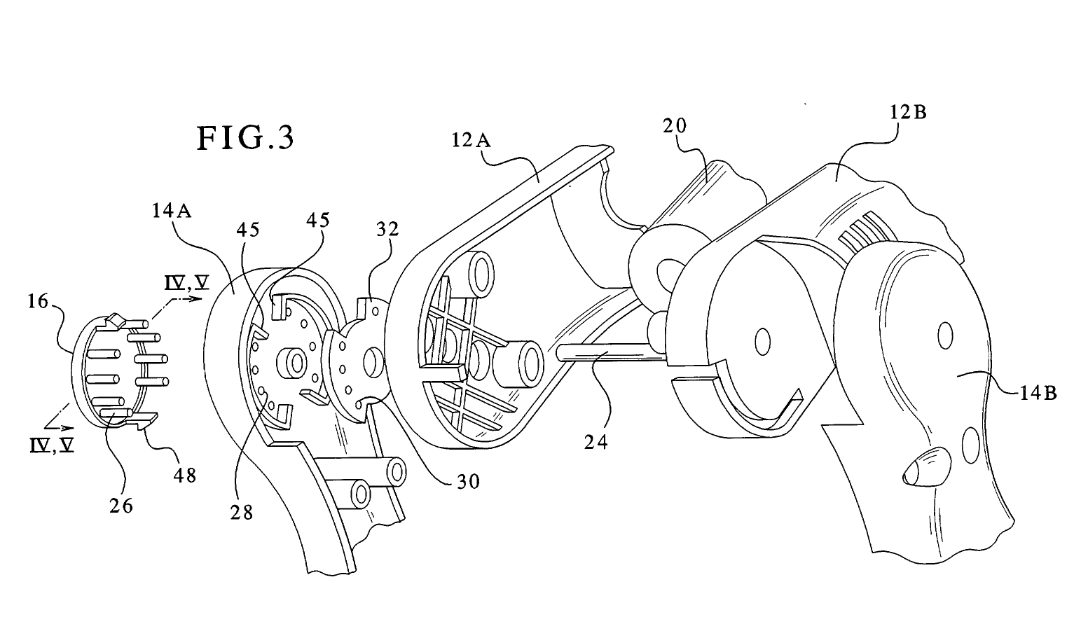

As most clearly seen in FIGS. 2 and 3, a shaft 24, such as a shoulder screw, extends through the handle housing half 14B, the motor housing half 12B, the motor housing half 12A, and finally through the handle housing half 14A. Preferably, the shoulder screw or shaft 24 includes a head that is seated on the outside of handle housing half 14B, and there is a female threaded portion on the inside of handle housing 14A for accepting a male threaded portion of shaft 24. This configuration will maintain the handle housing 14 and the motor housing 12 in an assembled position, but will still allow for pivoting about shaft 24. Optionally, a set of two holes 25 in both motor housings 12A and 12B may also be provided for use with two screws to even more securely maintain the motor housing together. However, these holes 25 and their associated screws may be eliminated. Additionally, other means for keeping the two different housings together, such as a tab and lip arrangement, are also contemplated as being within the scope of the invention.

The primary components of the articulation lock will now be described. It should be noted that the example shown is a four-position lock with a range of 0 through 135 degrees, but other numbers of positions and angular ranges (such as 90 degrees) are also contemplated. As can be seen in FIG. 3, the button 16 includes a series of protrusions 26. Since this example is a four-position tool, there are two sets of protrusions, with four protrusions 26 in each set (for a total of eight protrusions). Similarly, if the tool was a five-position tool, there would be five protrusions in each set (for a total of ten protrusions). Each of these protrusions 26 corresponds to an aperture 28 in the housing half 14A, as well as to an indexing aperture 30 in an indexing plate 32. The indexing plate 32 is configured to be seated within a recess in the handle housing 14A such that relative rotation between the indexing plate 32 and the handle housing 14A is prevented. Such relative rotation may be prevented by using one or more notches 44 on the indexing plate 32 that correspond to complementary stops 45 on the handle housing 14A, or by otherwise appropriately shaping the indexing plate 32 and the seating recess on the handle housing 14A.

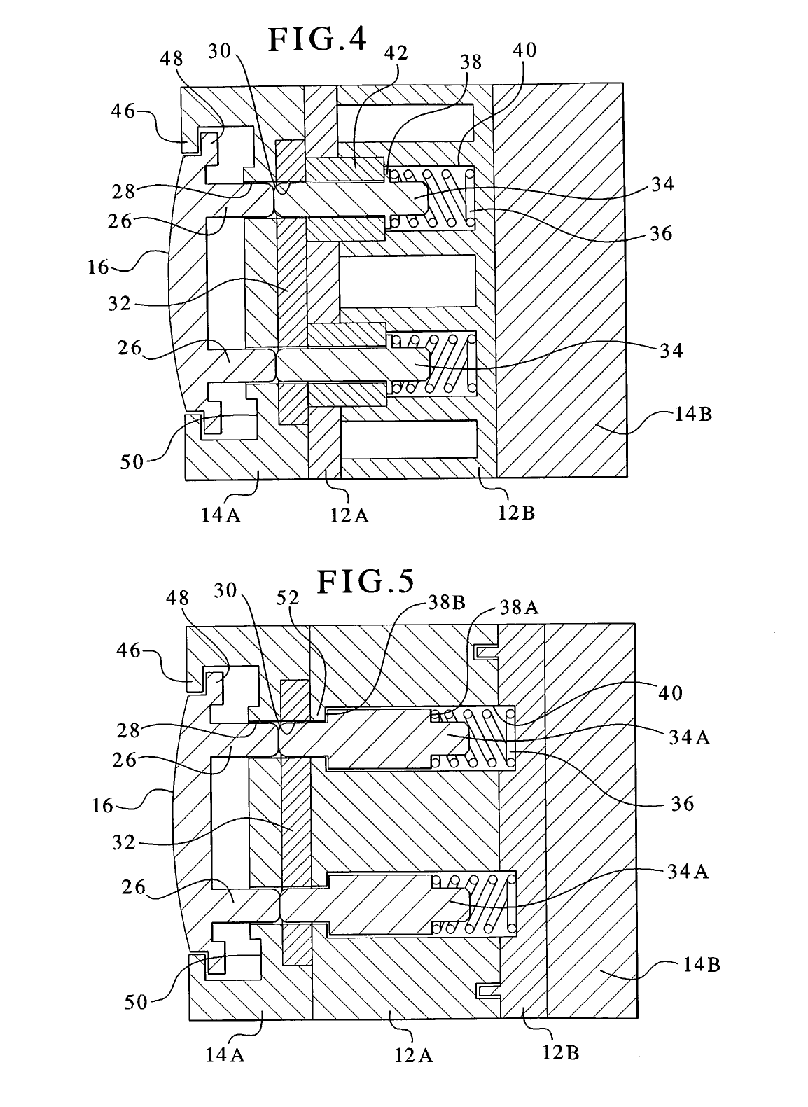

A lock pin assembly including two lock pins 34, two springs 36 and a seating arrangement for the pins and the springs is utilized to lock the motor housing 12 in position with respect to the handle housing 14. Turning now to FIG. 4, which is a cut-away view of FIG. 3, the lock pin assembly of the articulation lock will be described in further detail. In this embodiment, the lock pin 34 is preferably configured to include a shoulder 38, which is adapted for receiving a biasing force provided by the spring 36, that is seated within a cavity 40 (along with the lock pin 34). The biasing force is leftwardly directed (as oriented in the FIG. 4 view), and the lock pin 34 is maintained within the cavity 40 by being seated within a bushing 42, whereby when the left edge of the shoulder 38 makes contact with the right edge of the bushing 42. Further leftward movement of the lock pin 34 is prevented because the bushing 42 is press fit (or otherwise rigidly secured) into the cavity 40. Preferably, the bushing 42 is only press fit into motor housing half 12B and is slip fit into motor housing half 12A, in order to facilitate assembly. However, other securing methods and configurations are also contemplated.

In operation, when one wants to change the tool from one locked position to another locked position (i.e., to pivot the motor housing 12 with respect to the handle housing 14), the button 16 is depressed by the user. When the button 16 is pressed (in the rightward direction when referring to the FIG. 4 view), the protrusions 26 move from their initial position, where the right-hand ends of the protrusions 26 are somewhat to the left of or approximately level with the right-hand edges of the housing apertures 28, to a second position in which they are pushed into the indexing apertures 30. Such movement causes both of the lock pins 34 to be pushed against the force of the springs 36 by two of the protrusions 26. It should be noted that regardless of how the motor housing 12 and the handle housing 14 are positioned with respect to each other, six of the eight protrusions 26 are pushed into empty indexing apertures 30 (i.e., only one protrusion from each of the two sets of four protrusions 26 contacts a locking pin 34).

One important feature of the present invention is that a stop surface 50 is provided to prevent the button 16 from being pressed so far that the end of the protrusion 26 extends past the right-hand edge of the housing apertures 28. Since the protrusions 26 stop short of extending into the motor housing half 12A, the motor housing 12 may be rotated with respect to the handle housing 14 about the pivot point defined by the shaft 24 (see FIG. 3). This is the case because the indexing plate 32 (which the protrusions 26 do extend into) is fixed for rotation with the handle housing half 14A. Accordingly, when the button 16 is depressed, the button 16, the handle housing halves 14A and 14B and the indexing plate 32 are all fixed to rotate with the handle housing 14. On the other hand, the pins 34 the springs 36 and both motor housing halves 12A and 12B are fixed to rotate with the motor housing 12.

After the motor housing 12 is pivoted to the desired one of the four positions, the user releases the button 16. It should be noted that the button 16 is prevented from separating from handle housing half 14A by the interaction between overhang 46 and tabs 48. At this point, after being pivoted, two different protrusions 26 will be associated with the two lock pins 34 than the protrusions 26 that were originally associated with the lock pins 34 prior to the pivoting. The springs 36 bias the lock pins 34 leftwardly into the indexing apertures 30 in the indexing plate 32 (as viewed in FIG. 4), thereby preventing further rotation between the motor housing 12 and the handle housing 14 due to the fact that the indexing plate is fixed for rotation with the handle housing half 12A. While the locking pins 32 are entering the indexing apertures 30, the associated protrusions 26 are also biased leftwardly (in the FIG. 4 view), and out of the indexing apertures 30. Such biasing force returns the button 16 to the position shown in FIG. 4 (i.e., its initial position).

FIG. 5 shows an alternate embodiment of the lock pin structure. In this embodiment, components that are like those of the FIG. 4 embodiment use the same numbers as in FIG. 4. The primary difference between the FIG. 5 embodiment and the FIG. 4 embodiment relates to the lock pin, which has been designated as 34A in the FIG. 5 embodiment. As shown in FIG. 5, the lock pin 34A is a double-shouldered pin, with a first shoulder 38A and a second shoulder 38B. The first shoulder 38A provides a surface upon which the spring 36 may exert its biasing force to bias the lock pin 34A leftwardly (in the FIG. 5 view). The second shoulder 38B works in cooperation with overhanging lip portion 52 to prevent the lock pin 34A from being biased out of the cavity 40. In this embodiment, there is no bushing surrounding the lock pin due to the use of the two shoulders 38A and 38B. Otherwise, the FIG. 5 embodiment operates in essentially the same way as the FIG. 4 embodiment.

The components of the above-described screwdriver 10 are preferably made from the standard materials normally utilized for each component (such as metal for the springs, screws and shaft, plastic for the housings, etc.).

Assembly of the present screwdriver 10 is believed to be simplified over prior art devices. Basically, all of the relevant components are seated within one half of the motor housing 12, and then both halves of this housing are assembled. Next, the relevant components of the handle housing 14 are seated in the appropriate half of this housing, and the motor housing 12 is then sandwiched between the two halves of the handle housing 14. The assembly is then secured together by a shoulder screw 24, or the like, as well as any other fasteners that may be necessary or desired. Finally, the tabs 48 on the button 16 are pressed inwardly, and the button is seated in position.

While various embodiments of the present invention have been shown and described, it should be understood that other modifications, substitutions and alternatives may be apparent to one of ordinary skill in the art. Such modifications, substitutions and alternatives can be made without departing from the spirit and scope of the invention, which should be determined from the appended claims.

What is claimed is:

1. An articulation lock comprising:
a first housing;
a second housing;
a lockable connection assembly for pivotably connecting said first housing and said second housing together, wherein said lockable connection assembly includes:
a plurality of apertures arranged upon a portion of said second housing;
at least two lock pins, each of said lock pins seated within a cavity located within said first housing;
at least one biasing element for creating a biasing force upon each of said lock pins such that each of said lock pins are biased toward said second housing to prevent relative rotation of said first housing with respect to said second housing; and
an engaging member attached to said second housing, said engaging member including a plurality of protrusions, with one of said protrusions corresponding to each of said apertures in said second housing;
wherein upon pressing said engaging member towards said lock pins, at least two of said plurality of protrusions push said at least two lock pins against said biasing forces of said biasing elements, allowing relative rotation of said first housing with respect to said second housing.

2. The articulation lock as defined in claim 1, further comprising:
an indexing plate seated within a cavity in said second housing, said indexing plate and said cavity being configured and arranged such that relative rotation between said indexing plate and said second housing is prevented; and
a plurality of indexing apertures located in said indexing plate, with one of said indexing apertures corresponding to each of said apertures in said second housing;
wherein when said biasing element is fully biasing said lock pins toward said second housing, said lock pins each extend through one of said indexing apertures, but not through said apertures in said second housing; and
further wherein by pressing said engaging member towards said lock pins, said protrusions push said lock pins out of said indexing apertures, thereby allowing relative rotation of said first housing with respect to said second housing.

3. The articulation lock as defined in claim 1, wherein:
each of said lock pins includes an annular shoulder thereon; and
each of said cavities of said first housing includes a bushing securely fixed therein, such that said shoulder of each of said lock pins provides both a surface for said at least one biasing element to press against and a surface for making contact with said bushing to prevent said lock pin from being biased out of said cavity.

4. The articulation lock as defined in claim 2, wherein:
each of said lock pins includes a shoulder portion thereon; and
each of said cavities of said first housing includes a bushing securely fixed therein, such that said shoulder portion of each of said lock pins provides a first surface for said at least one biasing element to press against and a second surface for making contact with said bushing to prevent said lock pin from being biased out of said cavity.

5. The articulation lock as defined in claim 1, wherein:
each of said cavities includes a lip; and
each of said lock pins includes a shoulder portion, such that said lock pin is prevented from being biased out of said cavity by said shoulder portion contacting said lip.

6. The articulation lock as defined in claim 2, wherein:
each of said cavities includes a lip; and
each of said lock pins includes a shoulder portion, such that said lock pin is prevented from being biased out of said cavity by said shoulder portion contacting said lip.

7. An articulation lock comprising:
a first housing;
a second housing;
a lockable connection assembly for pivotably connecting said first housing and said second housing together, wherein said lockable connection assembly includes:
a shaft connected to said second housing and being configured and arranged for allowing rotation of said first housing with respect to said second housing;
a plurality of apertures arranged upon a portion of said second housing;
an indexing plate fixed for rotation with said second housing, and including a plurality of indexing apertures, with one of said indexing apertures corresponding to each of said plurality of apertures on said second housing;
at least two lock pins, each of said lock pins seated within a cavity located within said first housing;
a biasing element seated within each of said cavities, each of said biasing elements for creating a biasing force upon one of said lock pins such that each of said lock pins are biased to extend through one of said indexing apertures, thereby preventing relative rotation of said first housing with respect to said second housing; and
an engaging member attached to said second housing, said engaging member including a plurality of protrusions, with one of said protrusions corresponding to each of said indexing apertures;
wherein upon pressing said engaging member towards said lock pins, at least two of said plurality of protrusions push said at least two lock pins against said biasing force of said at least one biasing element, such that said lock pins are withdrawn from said indexing apertures, allowing relative rotation of said first housing with respect to said second housing.

8. The articulation lock as defined in claim 7, wherein:
each of said lock pins includes a shoulder portion thereon; and
each of said cavities of said first housing includes a bushing securely fixed therein, such that said shoulder portion of each of said lock pins provides a first surface for said at least one biasing element to press against and a second surface for making contact with said bushing to prevent said lock pin from being biased out of said cavity.

9. The articulation lock as defined in claim 7, wherein:
each of said cavities includes a lip; and
each of said lock pins includes a shoulder portion, such that said lock pin is prevented from being biased out of said cavity by said shoulder portion contacting said lip.

10. The articulation lock as defined in claim 7, wherein said engaging member includes four of said protrusions, said second housing includes four of said apertures, said indexing plate includes four of said indexing apertures, and said first housing includes two of said cavities, each for seating a single one of said two lock pins therein, whereby said first housing may be locked into any one of four different positions with respect to said second housing.

11. The articulation lock as defined in claim 7, wherein said first housing may be pivoted to any one of a plurality of positions with respect to said second housing within an approximately 90° arc.

12. The articulation lock as defined in claim 7, wherein said first housing may be pivoted to any one of a plurality of positions with respect to said second housing within an approximately 135° arc.

13. The articulation lock as defined in claim 7 wherein said indexing plate and a portion of said second housing for seating said indexing plate are each shaped in a complementary manner to prevent relative rotation therebetween.

14. A pivotable tool comprising:
a motor housing;
a handle housing;
a lockable connection assembly for pivotably connecting said motor housing and said handle housing together, wherein said lockable connection assembly includes:
a plurality of apertures arranged upon a portion of said handle housing;
at least two lock pins, each of said lock pins seated within a cavity located within said motor housing;
at least one biasing element for creating a biasing force upon each of said lock pins such that each of said lock pins are biased toward said handle housing to prevent relative rotation of said motor housing with respect to said handle housing; and
an engaging member attached to said handle housing, said engaging member including a plurality of protrusions, with one of said protrusions corresponding to each of said apertures in said handle housing;
wherein upon pressing said engaging member towards said lock pins, at least two of said plurality of protrusions push said at least two lock pins against said biasing force of said at least one biasing element, allowing relative rotation of said first housing with respect to said second housing.

15. The pivotable tool as defined in claim 14, further comprising:
an indexing plate seated within a cavity in said second housing, said indexing plate and said cavity being configured and arranged such that relative rotation between said indexing plate and said second housing is prevented; and
a plurality of indexing apertures located in said indexing plate, with one of said indexing apertures corresponding to each of said apertures in said second housing;
wherein when said biasing element is fully biasing said lock pins toward said second housing, said lock pins each extend through one of said indexing apertures, but not through said apertures in said second housing; and
further wherein by pressing said engaging member towards said lock pins, said protrusions push said lock pins out of said indexing apertures, thereby allowing relative rotation of said first housing with respect to said second housing.

16. The pivotable tool as defined in claim 14, wherein:
each of said lock pins includes an annular shoulder thereon; and
each of said cavities of said first housing includes a bushing securely fixed therein, such that said shoulder of each of said lock pins provides both a surface for said at least one biasing element to press against and a surface for making contact with said bushing to prevent said lock pin from being biased out of said cavity.

17. The pivotable tool as defined in claim 15, wherein:
each of said lock pins includes a shoulder portion thereon; and
each of said cavities of said first housing includes a bushing securely fixed therein, such that said shoulder portion of each of said lock pins provides a first surface for said at least one biasing element to press against and a second surface for making contact with said bushing to prevent said lock pin from being biased out of said cavity.

18. The pivotable tool as defined in claim 14,
each of said cavities includes a lip; and
each of said lock pins includes a shoulder portion, such that said lock pin is prevented from being biased out of said cavity by said shoulder portion contacting said lip.

19. The pivotable tool as defined in claim 14, wherein said handle housing sandwiches said motor housing therebetween.

20. The pivotable tool as defined in claim 14, wherein said tool comprises a cordless screwdriver.
